(19) United States
(12) Patent Application Publication
(10) Pub. No.: US 2013/0145025 A1
(43) Pub. Date: Jun. 6, 2013

(54) PROGRAMMABLE CONTROLLER

(71) Applicants: Hirokazu Ishikawa, Chiyoda-ku (JP); Tomoaki Takagi, Chiyoda-ku (JP)

(72) Inventors: Hirokazu Ishikawa, Chiyoda-ku (JP); Tomoaki Takagi, Chiyoda-ku (JP)

(73) Assignee: MITSUBISHI ELECTRIC CORPORATION, Chiyoda-ku, Tokyo (JP)

(21) Appl. No.: 13/817,191

(22) PCT Filed: Oct. 17, 2011
(86) PCT No.: PCT/JP2011/073853

§ 371 Date: Feb. 15, 2013

(30) Foreign Application Priority Data
Oct. 27, 2010 (JP) PCT/JP2010/069107

(51) Int. Cl. H04L 12/26

(52) U.S. Cl. CPC H04L 43/10
USPC 709/224

(57) ABSTRACT

The present invention includes a connection unit that performs reception of a request from an upper-level device and transmission of a response thereto via the established connection for each application; a communication buffer that temporarily stores requests received by the connection unit for each connection; a system main unit that reads a requested device value from the input/output memory area; a priority storage area that stores setting of a priority level for each connection; and a communication scheduling unit that successively obtains requests from the communication buffer, transfers the obtained request to the system main unit, and transfers the device value read by the system main unit to the connection unit as a response, wherein the communication scheduling unit obtains requests with a higher frequency for a connection for which a higher priority is set in the priority storage area.

### FIELD

The present invention relates to a programmable controller (PLC) that controls industrial devices.

### BACKGROUND

Some of the PLCs can be connected to an upper-level device such as a personal computer (hereinafter, PC) or a programmable display via a network. For example, Ethernet® is used as a communication system of the network. The connected upper-level device accesses the PLC using various applications.

Required response speeds differ according to types of the applications. For example, an application that configures a programming display needs a quick response in view of its characteristic of monitoring a device value of the PLC in real time. Production management software for collecting production data, or the like, in each cycle of a somewhat long span such as one day does not need such a quick response as the application performing real-time monitoring. In this way, some of the applications connected to a PLC require a quick response and there are applications that do not require the same.

However, a PLC demanded to perform a quick and accurate control has a limited CPU time that is allocated to communications with an upper-level device. Therefore, implementation of a mechanism that provides a preferential response to applications that require a quick response is demanded on the PLC side.

As a technique related to this demand, Patent Literature 1 discloses a technique that enables to set a transmission priority for a physical port of a communication device, for example.

### CITATION LIST

### Patent Literature

Patent Literature 1: Japanese Patent Application Laid-open No. 2010-109568

### SUMMARY

### Technical Problem

However, for example, when a plurality of applications running on a single computer perform communications, the same priority level is applied to all of these applications because the priority level is set for a physical port according to the conventional technique mentioned above.

The present invention has been achieved in view of the above problem and an object of the present invention is to provide a programmable controller that can preferentially respond to an application that requires a quick response.

### Solution to Problem

In order to solve the aforementioned problems, a programmable controller according to one aspect of the present invention, which is provided with an input/output memory area storing a device value therein and responds, when receiving a request for a device value from an upper-level device connected to the programmable controller, the requested device value, is configured in such a manner as to include: a connection unit that establishes a connection for each of applications running on the upper-level device and performs reception of a request from the upper-level device and transmission of a response to the upper-level device via the established connection for each of the applications; a communication buffer that temporarily stores therein requests received by the connection unit for each connection; a system main unit (a request processing unit) that reads a device value requested by the upper-level device from the input/output memory area; a priority storage area that stores setting of a priority level for each connection; and a communication scheduling unit that successively obtains requests from the communication buffer, transfers the obtained requests to the request processing unit, and transfers the device value, which is read by the request processing unit and corresponds to the transferred request, to the connection unit as a response, wherein the communication scheduling unit obtains requests from the communication buffer with a higher frequency for a connection for which a higher priority is set in the priority storage area.

### Advantageous Effects of Invention

The programmable controller according to the present invention executes a communication process related to a connection for which higher priority is set with a higher frequency and accordingly can preferentially respond to an application that requires a quick response.

When there are an application that requires a quick response and an application that permits a slow response, the programmable controller according to the present invention can respond quickly to the application that requires a quick response by setting high priority for a connection of the application that requires a quick response, even when an execution time of a service process is reduced.

### BRIEF DESCRIPTION OF DRAWINGS

FIG. 1 depicts a mode of using a PLC according to a first embodiment.

FIG. 2 is a flowchart for explaining characteristics of communication processes executed in a PLC according to a comparative example with an upper-level device.

FIG. 3 is a flowchart for explaining characteristics of communication processes of the PLC according to the first embodiment.

FIG. 4 is an explanatory diagram of a hardware configuration example of the PLC according to the first embodiment.

FIG. 5 is an explanatory diagram of a functional configuration of the PLC according to the first embodiment.

FIG. 6 is an example of a data structure of priority-level information.

FIG. 7 is an example of a creation screen for priority-level information.

FIG. 8 is a flowchart for explaining an operation of the PLC according to the first embodiment.

FIG. 9 is an explanatory diagram of a functional configuration of a PLC according to a second embodiment.

FIG. 10 is a flowchart for explaining an operation of the PLC according to the second embodiment.

FIG. 11 is an explanatory diagram of a functional configuration of a PLC according to a third embodiment.

FIG. 12 is a flowchart for explaining an operation of the PLC according to the third embodiment.

FIG. 13 is an explanatory diagram of a timeline of communication processes according to the third embodiment.

### DESCRIPTION OF EMBODIMENTS

Exemplary embodiments of a PLC according to the present invention will be explained below in detail with reference to the accompanying drawings. The present invention is not limited to the embodiments.

### First Embodiment

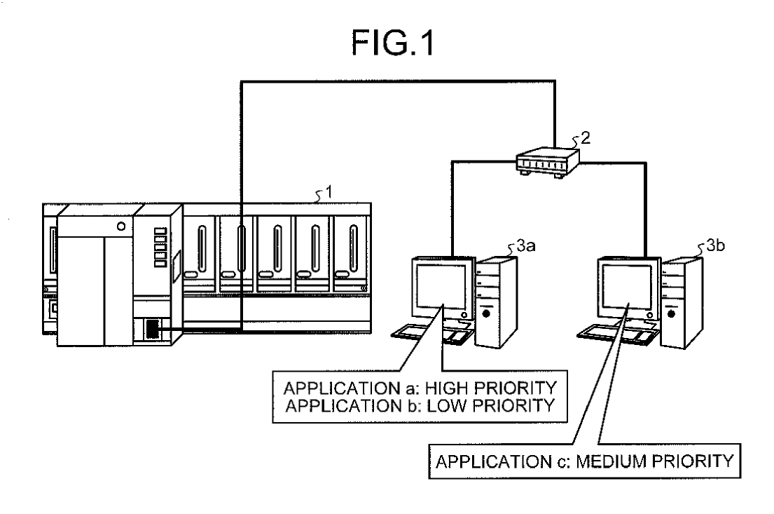

FIG. 1 depicts a mode of using a PLC according to a first embodiment of the present invention. As shown in FIG. 1, a PLC 1 is connected through a network hub 2 to a plurality of PCs (two PCs 3a and 3b in this case) via a network. For example, Ethernet® is adopted as a communication system of the network. Application “a” and application “b” run on the PC 3a, and application “c” runs on the PC 3b. The applications “a”, “b”, and “c” each issue a request to the PLC 1 and the PLC 1 returns a response to the corresponding request issuer. The request is a read request for a device value, and the response is a device value for which the read request is issued and is read from an input/output memory area provided in the PLC 1 itself. That is, the PCs 3a and 3b (the applications “a”, “b”, and “c”) function as upper-level devices of the PLC 1, respectively. In addition to the PCs, devices that function as upper-level devices of the PLC 1 include a programmable display and the like.

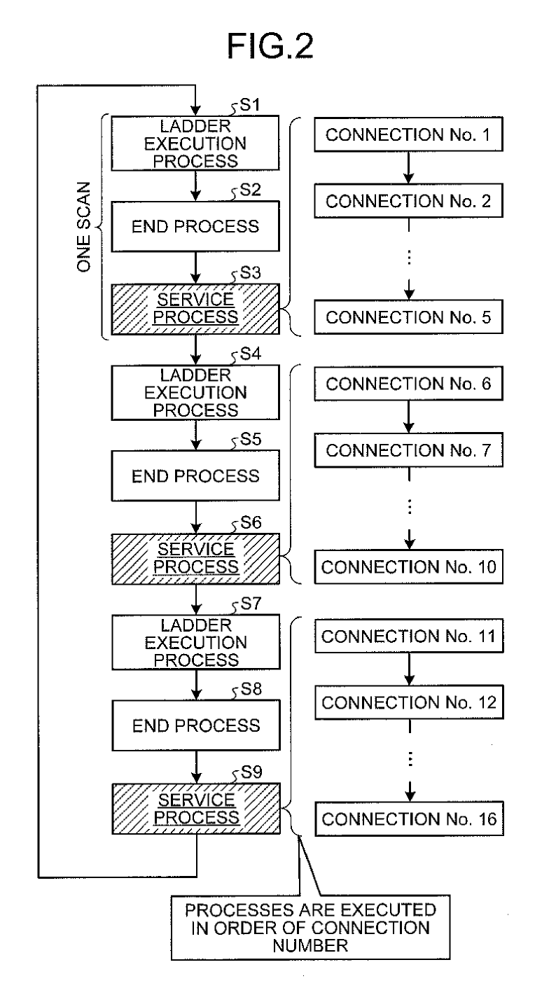

FIG. 2 is a flowchart for explaining characteristics of communication processes executed in a PLC with an upper-level device, to be compared with the first embodiment. More specifically, each communication process indicates an operation of reading a request from an upper-level device accumulated in a communication buffer of the PLC and returning a response thereto. An example shown in the flowchart is referred to as “comparative example”.

According to the comparative example, processing in one scan, composed of a ladder execution process, an end process, and a service process, is cyclically executed in the PLC at Steps S1 to S3, at Steps S4 to S6, and at Steps S7 to S9. After the scan at Steps S7 to S9, the scan at Steps S1 to S3 is performed. A user program is executed in the ladder execution process (Steps S1, S4, and S7), and a process of reflecting an arithmetic result of the user program in an input/output memory area is executed in the end process (Steps S2, S5, and S8). Communication processes with the upper-level device are executed in the service process (Steps S3, S6, and S9).

A CPU time allocated to the service process is limited to a certain time. Therefore, when 16 connections are formed with applications of an upper-level device in this case, communication processes related to five connections (connections Nos. 1 to 5) among the 16 connections are executed in the service process (Step S3) of the first scan, communication processes related to next five connections (connections Nos. 6 to 10) are executed in the service process (Step S6) of the second scan, and communication processes related to last six connections (connections Nos. 11 to 16) are executed in the third service process (Step S9). In this way, according to the comparative example, the communication processes for all the connections are completed once in plural scans. The communication processes for the respective connections are executed with the same frequency.

As described above, required communication speeds differ according to applications connected to the PLC 1. However, because the communication process is executed for each of the applications once every three scans in the comparative example shown in FIG. 2, it implies that communications with all the applications are performed at the same response speed. Therefore, the first embodiment is configured to change the frequency of executing the communication process according to a priority level that is set for each application, so that the response speed can be changed accordingly.

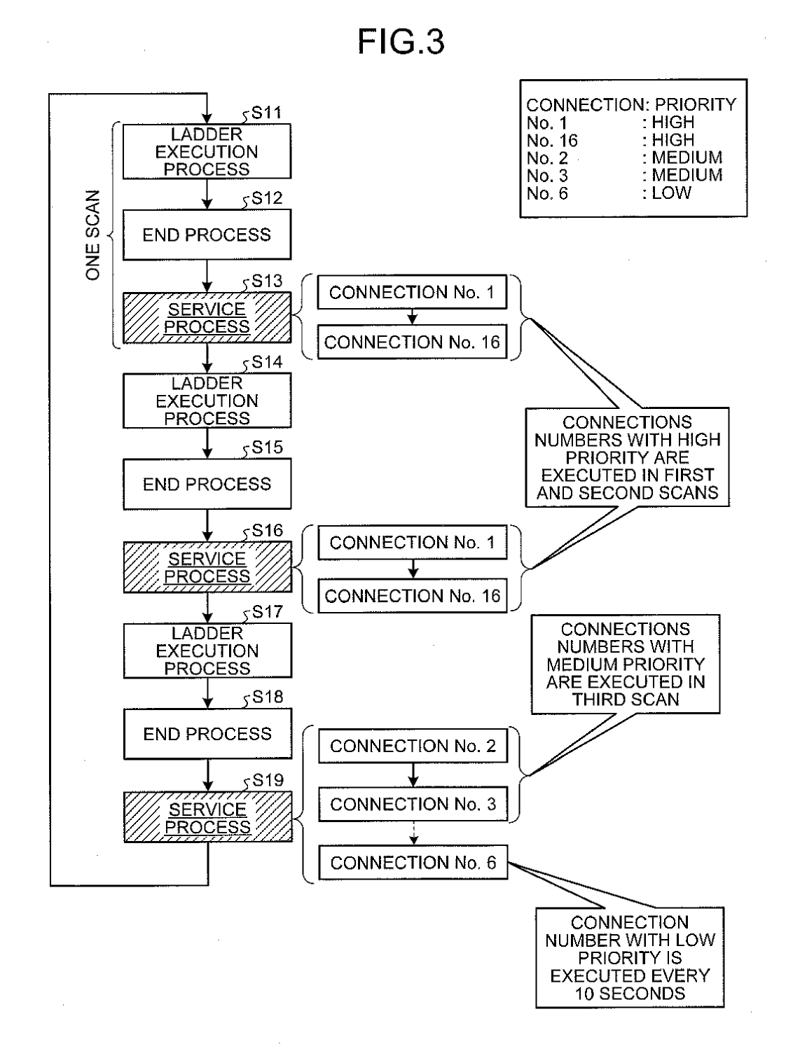

FIG. 3 is a flowchart for explaining characteristics of communication processes according to the first embodiment. According to the first embodiment, as shown in FIG. 3, the ladder execution process, the end process, and the service process are executed in each scan, as in the comparative example. One of three priority levels is set to each connection. In this case, “high” priority is set to applications connected through connections Nos. 1 and 16, “medium” priority is set to applications connected through connections Nos. 2 and 3, and “low” priority is set to an application connected through a connection No. 6. Communication processes related to the connections with “high” priority are executed in the service process (Steps S13 and S16) in two scans among three, and communication processes related to the connections with “medium” priority are executed in the service process (Step S19) in one scan among the three. A communication process related to the connection “low” priority is executed in the service process at a time interval previously set by a user (in the service process at Step S19 in this case). In this way, according to the first embodiment, the communication processes with the applications running on the connected devices are each executed with a frequency according to the priority level previously set, and an application for which higher priority level is set is enabled to return a response more quickly.

In the example shown in FIG. 1, the high, low, and medium levels of communication priority are set in the PLC 1 for the applications “a”, “b”, and “c”, respectively. The PLC 1 executes the communication process at a highest frequency with the application “a” having high priority, and executes the communication process with a lower frequency than that of the application “a” with the application “c” having the medium priority. The PLC 1 executes the communication process with the application “b” having the low priority at an interval of time (time intervals) previously set by a user, which is lower than the interval of the communication process with the application “c”.

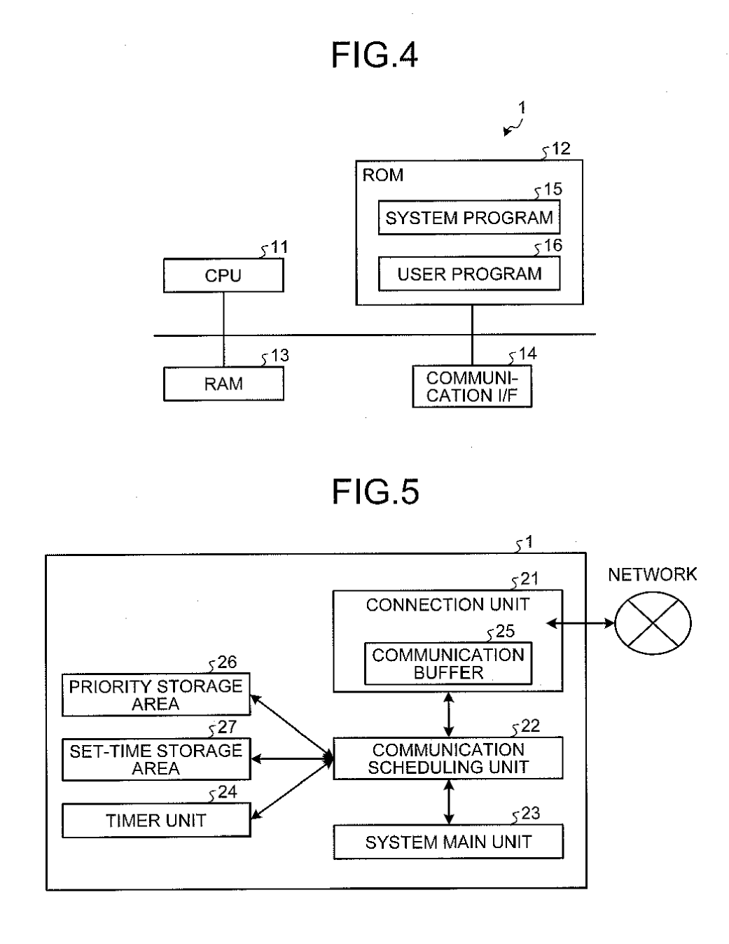

FIG. 4 is an explanatory diagram of a hardware configuration example of the PLC 1 according to the first embodiment. As shown in FIG. 4, the PLC 1 has the same configuration as that of a general computer and includes a central processing unit (CPU) 11, a read only memory (ROM) 12, a random access memory (RAM) 13, and a communication interface (I/F) 14. The CPU 11, the ROM 12, the RAM 13, and the communication I/F 14 are connected with one another via a bus line.

A system program 15 of the PLC 1 and a user program 16 created by a user are stored in the ROM 12. The system program 15 executes priority management of the communication processes during the service process mentioned above as a part of resource management of the PLC 1. The user program 16 is executed by the CPU 11 during the ladder execution process.

A program decompression area, a work area, an input/output memory area, and the like are provided in the RAM 13.

The CPU 11 executes the system program 15 and the user program 16. Specifically, the system program 15 and the user program 16 are read from the ROM 12 and decompressed in the program decompression area provided in the RAM 13. The CPU 11 executed the system program 15 decompressed in the RAM 13 to realize functions explained later, thereby executing the communication process according to each of the priorities in the service process. In the ladder execution process, the CPU 11 executes the user program 16 decompressed in the RAM 13. The CPU 11 executes the end process to perform input/output operations of a device value stored in the input/output memory area.

The communication I/F 14 is a connection interface for connecting the PLC 1 to a network, and is the general term for a network controller unit and a physical connector.

FIG. 5 is an explanatory diagram of a functional configuration of the PLC 1 according to the first embodiment, which is realized by execution of the system program 15. As shown in FIG. 5, the PLC 1 includes a connection unit 21, a communication scheduling unit 22, a system main unit (request processing unit) 23, a timer unit 24, a priority storage area 26, and a set-time storage area 27. The connection unit 21, the communication scheduling unit 22, the system main unit 23, the timer unit 24, the priority storage area 26, and the set-time storage area 27 are provided in the RAM 13. The connection unit 21 includes a communication buffer 25. The communication I/F 14 can include a storage device such as a memory or a register, and the connection unit 21 can use the storage device as the communication buffer 25.

The system main unit 23 performs a basic control including the resource management of the PLC 1. In this case, the system main unit 23 especially reads a device value requested by a request received by the connection unit 21 from the input/output memory area in the RAM 13.

The communication buffer 25 is a buffer memory for communications with upper-level devices (hereinafter a case of in which one upper-level device is connected is explained for simplicity). Requests from an upper-level device are temporarily stored (buffered) in the communication buffer 25.

The connection unit 21 associates an Internet Protocol (IP) address and a port number of a upper-level device to be connected with a port number of its own PLC 1 to establish a connection, and performs buffering of a request from the upper-level device into the communication buffer 25 and transmission of a response to the upper-level device generated by the system main unit 23, with respect to each connection. As a communication protocol for connection establishment, a general communication protocol such as a BSD socket can be adopted or a dedicated communication protocol can be created and used. Any communication protocol which will be developed in the future can also be adopted.

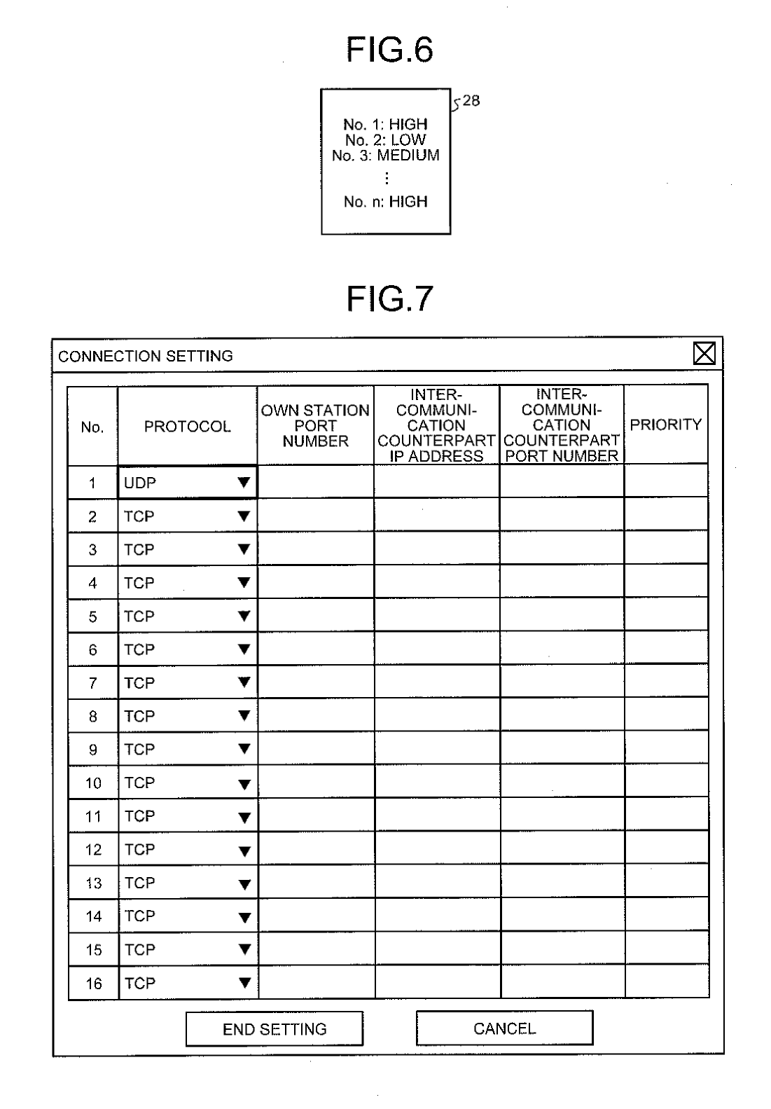

Information that defines the priority of each connection (priority information) is set in the priority storage area 26. The priority information is set by a user using a programming device, for example. FIG. 6 is an example of a data structure of the priority information stored in the priority storage area 26. As shown in FIG. 6, priority information 28 has a data structure in which a connection identification number and a priority level are associated with each other with respect to each connection.

FIG. 7 is an example of a creation screen for the priority information 28 in a programming device. As shown in FIG. 7, a table including fields for entering “protocol”, “port number of its own station” (own PLC 1), “IP address of an intercommunication counterpart” (a connected upper-level device), “port number of the intercommunication counterpart” (a port number used by an application that runs on the upper-level device), and “priority” is displayed in the creation screen example. Users can set up to 16 connections and corresponding priority levels of the connections by inputting desired values in the table. In the PLC 1, the priority information 28 is registered based on the information input in the creation screen, and the connection unit 21 establishes the connections.

Setting of the time interval between the communication processes related to connections with “low” priority is stored in the set-time storage area 27. The time interval is set by a programming device or the like, in the same manner as the priority.

The timer unit 24 counts elapsed time.

In the service process, the communication scheduling unit 22 refers to the priority information 28 stored in the priority storage area 26 or refers to a count value of the timer unit 24 to confirm that the time interval set in the set-time storage area 27 has elapsed, and selects a connection to which the communication process is to be executed. The communication scheduling unit 22 then obtains a request related to the selected connection from the communication buffer 25 and transfers the obtained request to the system main unit 23. The communication scheduling unit 22 transfers a device value read by the system main unit 23 according to the request transferred from the communication buffer 25 to the system main unit 23, as a response to the connection unit 21.

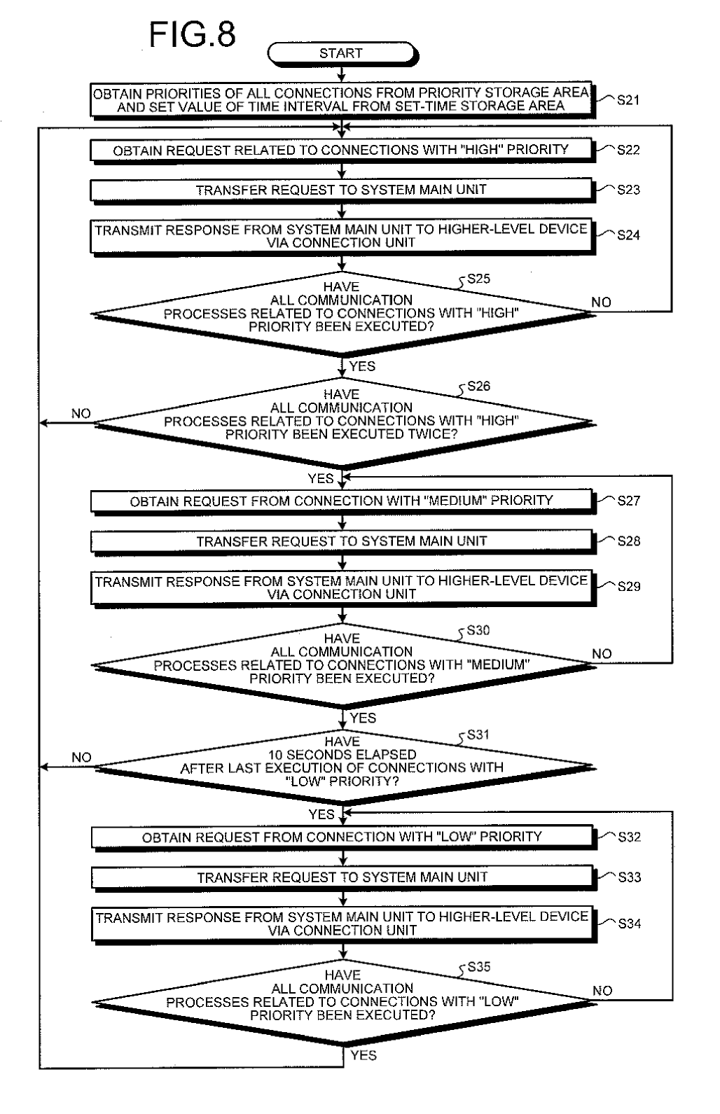

FIG. 8 is a flowchart for explaining an operation of the PLC 1 according to the first embodiment. As shown in FIG. 8, when the PLC 1 starts an operation (RUN) related to the user program 16, the communication scheduling unit 22 first obtains priority levels of all connections by referring to the priority information 28 and obtains the set time interval by referring to the set-time storage area 27 (Step S21). While the connection unit 21 establishes connections with upper-level devices upon starting of RUN of the PLC 1, explanations of an operation thereof are omitted in this case. It is assumed in this case that the time interval of 10 seconds is set in the set-time storage area 27.

Loop processing from Step S22 to Step S32 is executed in the service process to be divided into one or more scans. This is because a CPU time allocated to the communication process in one scan is limited to a time desired by a user. At Step S22, the communication scheduling unit 22 obtains one request related to connections with “high” priority from the communication buffer 25 (Step S22), and then transfers the request to the system main unit 23 (Step S23). Upon receipt of a response from the system main unit 23 to the transferred request, the communication scheduling unit 22 transfers the received response to the connection unit 21, and the connection unit 21 transmits the transferred response to the corresponding upper-level device (Step S24).

The communication scheduling unit 22 then determines whether all communication processes related to the connections with “high” priority have been executed (Step S25) and, when there is a communication process that is not executed yet (NO at Step S25), the operation returns to Step S22.

When all of the communication processes related to the connections with “high” priority have been executed (YES at Step S25), the communication scheduling unit 22 determines whether all of the communication processes related to the connections with “high” priority have been executed twice (Step S26) and, when not all the communication processes have been executed twice (NO at Step S26), the operation returns to Step S22.

When all of the communication processes related to the connections with “high” priority have been executed twice (YES at Step S26), the communication scheduling unit 22 obtains one request related to connections with “medium” priority (Step S27). The communication scheduling unit 22 transfers the obtained request to the system main unit 23 (Step S28). Upon receipt of a response from the system main unit 23 to the transferred request, the communication scheduling unit 22 transfers the received response to the connection unit 21 and then the connection unit 21 transmits the transferred response to the upper-level device (Step S29).

The communication scheduling unit 22 then determines whether all communication processes related to the connections with “medium” priority have been executed (Step S30) and, when execution of all the communication processes is not completed (NO at Step S30), the operation returns to Step S27.

When all of the communication processes related to the connections with “medium” priority have been executed (YES at Step S30), the communication scheduling unit 22 refers to a count value of the timer unit 24 to determine whether 10 seconds have elapsed after last execution of communication processes related to connections with “low” priority (Step S31). When 10 seconds have not elapsed (NO at Step S31), the operation returns to Step S22.

When 10 seconds have elapsed after the last execution of communication processes related to the connections with the “low” priority (YES at Step S31), the communication scheduling unit 22 obtains one request related to connections with “low” priority (Step S32). The communication scheduling unit 22 then transfers the obtained request to the system main unit 23 (Step S33). Upon receipt of a response from the system main unit 23 to the transferred request, the communication scheduling unit 22 transfers the received response to the connection unit 21 and then the connection unit 21 transmits the transferred response to the upper-level device (Step S34).

The communication scheduling unit 22 then determines whether all communication processes related to the connections with “low” priority have been executed (Step S35) and, when execution of all the communication processes is not completed (NO at Step S35), the operation returns to Step S32. When all of the communication processes related to the connections with “low” priority have been executed (YES at Step S35), the operation returns to Step S22.

While the operation has been explained assuming that the three levels of priority, namely, “high”, “medium”, and “low” levels can be set, a plurality of levels of priority can be set, rather than the three levels.

While the frequency of the communication processes related to the connections for which “low” priority is set is specified by setting the time interval, frequencies of the connections with priorities other than “low” priority can be similarly specified by setting the corresponding time intervals.

Alternatively, the frequency of the communication processes related to the connections with all the priorities can be specified by the number of times of communication processes, respectively, in the same manner as the connections with “high” and “medium” priorities explained above, not by setting the corresponding time intervals. That is, for example, the communication processes related to the connections with “high” priority are executed three times, the communication processes related to the connections with “medium” priority are executed twice, and the communication processes related to the connections with “low” priority are executed once.

As described above, according to the first embodiment, the PLC 1 includes the connection unit 21 that performs reception of requests from one or more upper-level devices and transmission of responses to the corresponding upper-level device via connections for each application, the communication buffer 25 that temporarily stores therein the requests received by the connection unit 21 with respect to each connection, the system main unit (request processing unit) 23 that reads a device value requested by the upper-level device from the input/output memory area, the priority storage area 26 that stores the setting of priority for each of the connections, and the communication scheduling unit 22 that successively obtains the requests from the communication buffer to transfer the requests to the request processing unit 23 and transfers the device value read by the system main unit 23 to the connection unit 21 as a response to each request. The communication scheduling unit 22 is configured to obtain requests related to connections for which higher priority is set in the priority storage area 26 with a higher frequency from the communication buffer 25. Accordingly, communication processes related to the connections for which higher priority is set are executed with a higher frequency and thus the PLC 1 is enabled to preferentially respond to an application that requires a quicker response.

The PLC 1 further includes the timer unit 24 that counts elapsed time and the set-time storage area 27 that stores setting of the time interval therein. The communication scheduling unit 22 refers to a count value of the timer unit 24 to determine whether the time interval set in the set-time storage area 27 has elapsed and, when the time interval has elapsed, obtains a request related to the connection for which specific priority is set in the priority storage area 26, from the communication buffer 25. Therefore, users can execute the communication processes at a desired time interval for a specific application.

### Second Embodiment

In the second embodiment, the PLC stores the number of responses per unit time to communication requests related to connections of respective priority levels in an input/output memory area as a device value so as to quantitatively know a communication process status related to connections of each application. Users can confirm that communication processes are executed for a target application at a desired priority level by referring to the device value using a programmable display, or the like.

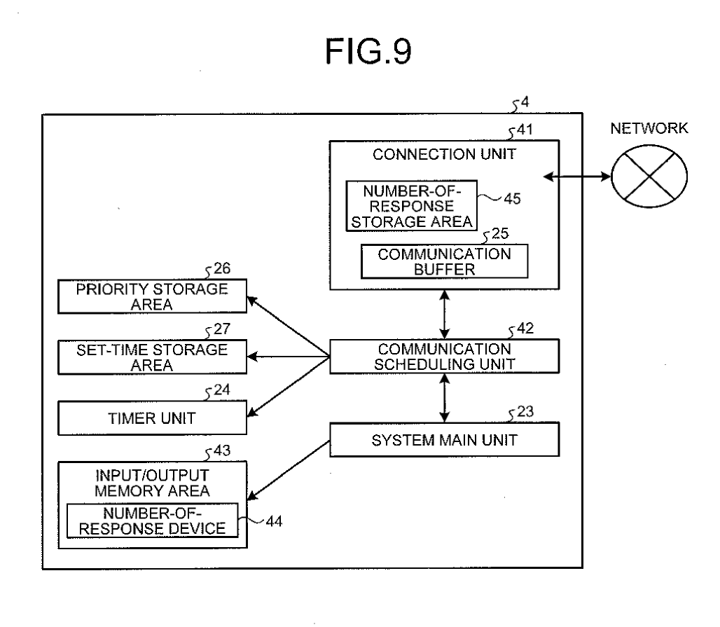

FIG. 9 is an explanatory diagram of a functional configuration of a PLC according to the second embodiment. Constituent elements identical to those of the first embodiment are denoted by same reference signs, and redundant explanations thereof will be omitted.

As shown in FIG. 9, a PLC 4 according to the second embodiment includes a connection unit 41, a communication scheduling unit 42, the system main unit (request processing unit) 23, the timer unit 24, the priority storage area 26, the set-time storage area 27, and an input/output memory area 43. The connection unit 41 includes the communication buffer 25 and a number-of-response storage area 44.

The number-of-response storage area 45 is configured by a storage device such as a memory or a register and stores the number of responses with respect to each connection. Location of the number-of-response storage area 45 is not limited to a specific position, as the communication buffer 25.

The input/output memory area 43 is provided in the RAM 13, and a number-of-response device 44 that has state information related the number of responses stored therein is allocated thereto. State information of each connection is stored in the number-of-response device 44. Here, the state information indicates the number of responses per unit time for each connection. The number-of-response device 44 is updated by the system main unit 23. While a device related to the user program 16 (a device updated in the end process mentioned above) is allocated to the input/output memory area 43 in addition to the number-of-response device 44, this device is not shown in FIG. 9.

The connection unit 41 performs management of a storage value in the number-of-response storage area 45, in addition to the same operation as that in the first embodiment. Specifically, each time a response is transmitted to an upper-level device, the connection unit 41 increments the number of responses related to a connection of the response destination, stored in the number-of-response storage area 45.

The communication scheduling unit 42 functions as a state-information calculation unit that calculates the state information (the number of responses per unit time in this case) based on a storage value in the number-of-response storage area 45 and stores the calculated state information in the number-of-response device 44, in addition to performing the same operation as that in the first embodiment. Because it is assumed in this case that the state information of each connection is stored in the number-of-response device 44, the communication scheduling unit 42 calculates the state information of each connection.

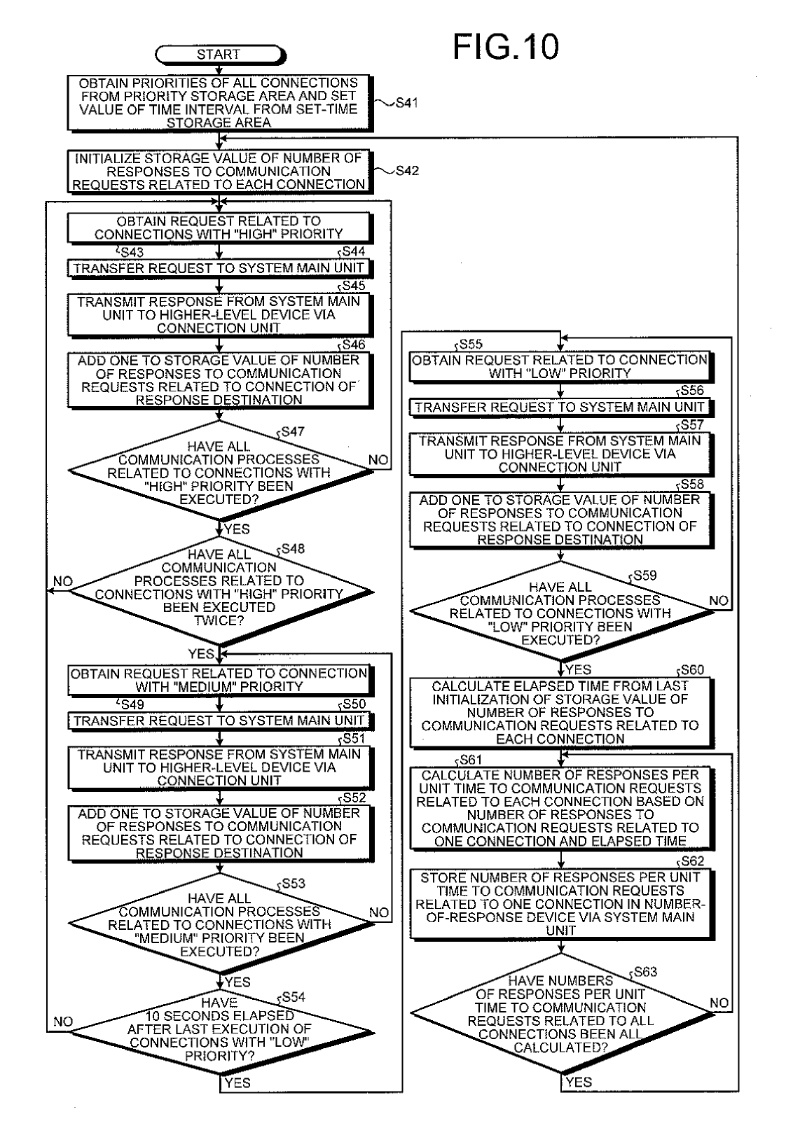

FIG. 10 is a flowchart for explaining an operation of the PLC 4 according to the second embodiment. It is assumed in this case that priority information stored in the priority storage area 26 and a set value of the time interval stored in the set-time storage area 27 are same as those in the first embodiment. That is, the communication processes related to “high” priority are executed in the service process in two scans among three, and the communication processes related to connections with “medium” priority are executed in the service process in one scan among the three. The communication processes related to connections with “low” priority are executed every 10 seconds.

When the PLC 4 starts an operation (RUN) related to the user program 16, the communication scheduling unit 42 first obtains priorities of all connections by referring to the priority information 28, and also obtains a set time interval by referring to the set-time storage area 27 (Step S41). The communication scheduling unit 42 then instructs the connection unit 41 to perform initialization of the number-of-response storage area 45 having the number of responses to communication requests related to each connection stored therein (Step S42).

The communication scheduling unit 42 then obtains one request related to connections with the “high” priority from the communication buffer 25 (Step S43), and then transfers the thus obtained request to the system main unit 23 (Step S44). The communication scheduling unit 42 then transmits a response to the request received from the system main unit 23 to the corresponding upper-level device via the connection unit 41 (Step S45). At that time, the connection unit 41 adds one to a storage value in the number-of-response storage area 45 with respect to communication requests related to a connection of the response destination (Step S46).

The communication scheduling unit 42 then determines whether all communication processes related to the connections with “high” priority have been executed (Step S47) and, when there is a communication process that is not executed yet (NO at Step S47), the operation returns to Step S43. When all of the communication processes related to the connection with “high” priority have been executed (YES at Step S47), the communication scheduling unit 42 determines whether all of the communication processes related to the connections with “high” priority have been executed twice (Step S48) and, when not all the communication processes have been executed twice (NO at Step S48), the operation returns to Step S43.

When all of the communication processes related to the connections with “high” priority have been executed twice (YES at Step S48), the communication scheduling unit 42 obtains one request related to connections with “medium” priority (Step S49). The communication scheduling unit 42 then transfers the obtained request to the system main unit 23 (Step S50). Upon receipt of a response from the system main unit 23 to the transferred request, the communication scheduling unit 42 transfers the received response to the connection unit 41 and the connection unit 41 transmits the transferred response to the upper-level device (Step S51). At that time, the connection unit 41 adds one to the storage value in the number-of-response storage area 45 with respect to communication requests related to a connection of the response destination (Step S52).

The communication scheduling unit 42 then determines whether all communication processes related to the connections with “medium” priority have been executed (Step S53) and, when execution thereof is not completed yet (NO at Step S53), the operation returns to Step S49.

When all of the communication processes related to the connections with “medium” priority have been executed (YES at Step S53), the communication scheduling unit 42 refers to a count value in the timer unit 24 to determine whether 10 seconds have elapsed from last execution of communication processes related to connections with “low” priority (Step S54). When 10 seconds have not elapsed yet from the last communication process related to connections with “low” priority (NO at Step S54), the operation returns to Step S43.

When 10 seconds have elapsed from the last execution of communication processes related to connections with “low” priority (YES at Step S54), the communication scheduling unit 42 obtains one request related to connections with “low” priority (Step S55). The communication scheduling unit 42 then transfers the obtained request to the system main unit 23 (Step S56). Upon receipt of a response from the system main unit 23 to the transferred request, the communication scheduling unit 42 transfers the received response to the connection unit 41 and the connection unit 41 transmits the transferred response to the upper-level device (Step S57). At that time, the connection unit 41 adds one to the storage value of the number-of-response storage area 45 with respect to communication requests related to a connection of the response destination (Step S58).

The communication scheduling unit 42 then determines whether all communication processes related to connections with “low” priority have been executed (Step S59) and, when execution thereof is not completed yet (NO at Step S59), the operation returns to Step S55.

When all of the communication processes related to the connections with “low” priority have been executed (YES at Step S59), the communication scheduling unit 42 refers a count value of the timer unit 24, and calculates an elapsed time from execution of the process at Step S42, that is, an elapsed time from last initialization of the number of responses stored in the number-of-response storage area 45 with respect to each connection (Step S60). The communication scheduling unit 42 then obtains a stored value in the number-of-response storage area 45 with respect to communication requests related to one connection from the connection unit 41, and divides the obtained storage value in the number-of-response storage area 45 with respect to the communication requests related to the connection by the elapsed time calculated by the process at Step S60 so as to calculate the number of responses per unit time with respect to the communication process related to the connection (Step S61). The communication scheduling unit 42 then transfers the calculated number of responses per unit time to the system main unit 23, and the system main unit 23 stores the received number of responses per unit time in the number-of-response device 44 (Step S62).

The communication scheduling unit 42 then determines whether the numbers of responses per unit time related to all connections have been calculated (Step S63) and, when there is a connection for which the number of responses per unit time has not been calculated yet (NO at Step S63), the operation returns to Step S61. When the numbers of responses per unit time related to all the connections have been calculated (YES at Step S63), the operation returns to Step S42.

As described above, according to the second embodiment, the number-of-response storage area 45 that has the number of responses with respect to each connection stored therein is provided, and the communication scheduling unit 42 is configured to calculate the state information related to the number of responses with respect to each connection based on the storage value in the number-of-response storage area 45 and to store the calculated state information with respect to each connection in a predetermined device (the number-of-response device 44) in the input/output memory area 43. Therefore, users can quantitatively know a status of the communication process related to the connection of each application by referring to a value of the device.

Although the number of responses to communication requests is stored in the number-of-response storage area 45 for each connection and the communication scheduling unit 42 calculates the number of responses per unit time for each connection in the above explanations, storage of the number of responses and calculation of the number of responses per unit time can be performed not for each connection but for each priority, which is a unit having a larger grading than that of a connection. That is, the number of responses at least for each priority can be stored in the number-of-response storage area 45, the state information at least for each priority can be stored in the number-of-response device 44, and the communication scheduling unit 42 can calculate the state information at least with respect to each priority.

A timing of calculating the number of responses per unit time is not limited only to a timing after all of the communication processes related to the connections with “low” priority have been executed. For example, the number of responses per unit time may be calculated at a timing after communication processes of each connection are completed or at the timing after communication processes related to all connections for each priority are completed.

While the state information stored in the number-of-response device 44 is the number of responses per unit time in the above explanations, any value can be adopted as long as it enables to check the state of a response. For example, an integration value of the numbers of responses can be adopted.

### Third Embodiment

In the first and second embodiments, the time interval of 10 seconds is set in the set-time storage area 27 for the communication processes related to the “low” priority, and the communication processes related to the “low” priority are executed every 10 seconds. It is assumed here that a time-out value of the application “c” with “low” priority is set to 9 seconds. When a request of the application “c” with “low” priority is stored in the communication buffer 25 immediately after a communication process related to a connection with “low” priority is executed, transfer of a response to the request of the application “c” is performed substantially 10 seconds after the request of the application “c” is stored in the communication buffer 25. However, the application “c” has already timed out when the request is executed, and thus transfer of the response becomes an error. According to a third embodiment, in order to overcome the situation in which a communication by a communication process with “low” priority is disabled due to a time-out error, a set time in the set-time storage area 27 is changed to a smaller value when transfer of a response in the communication process related to a connection with “low” priority becomes an error.

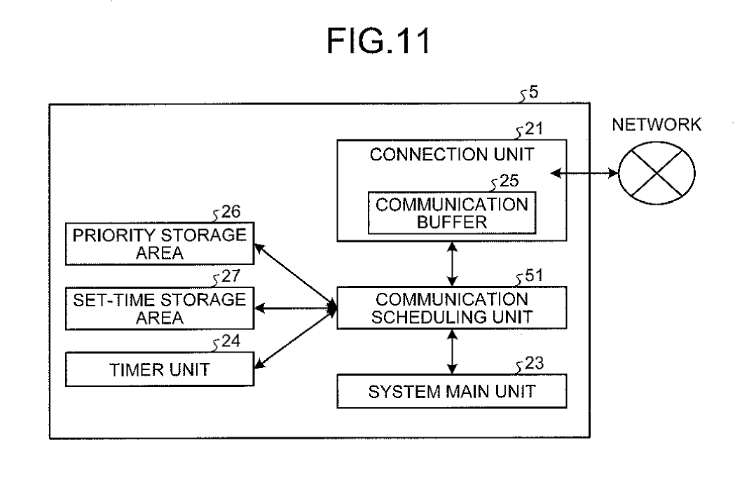

FIG. 11 is an explanatory diagram of a functional configuration of a PLC according to the third embodiment. Constituent elements identical to those of the first embodiment are denoted by same reference signs, and redundant explanations thereof will be omitted.

As shown in FIG. 11, a PLC 5 according to the third embodiment includes the connection unit 21, a communication scheduling unit 51, the system main unit (request processing unit) 23, the timer unit 24, the priority storage area 26, and the set-time storage area 27. The connection unit 21 includes the communication buffer 25.

The communication scheduling unit 51 performs the same operation as that in the first embodiment and also functions as a set-time reset unit that resets the time interval set in the set-time storage area 27 to a smaller value when a time-out error occurs in a connection for which priority that causes communication processes to be executed at the time intervals set in the set-time storage area 27 (that is, “low” priority) is set. A method by which the communication scheduling unit 51 detects occurrence of a time-out error is not particularly limited. In this example, the connection unit 21 stores therein occurrence of a time-out error (hereinafter, simply “error”) and the communication scheduling unit 51 inquires of the connection unit 21 to know whether a time-out error has occurred.

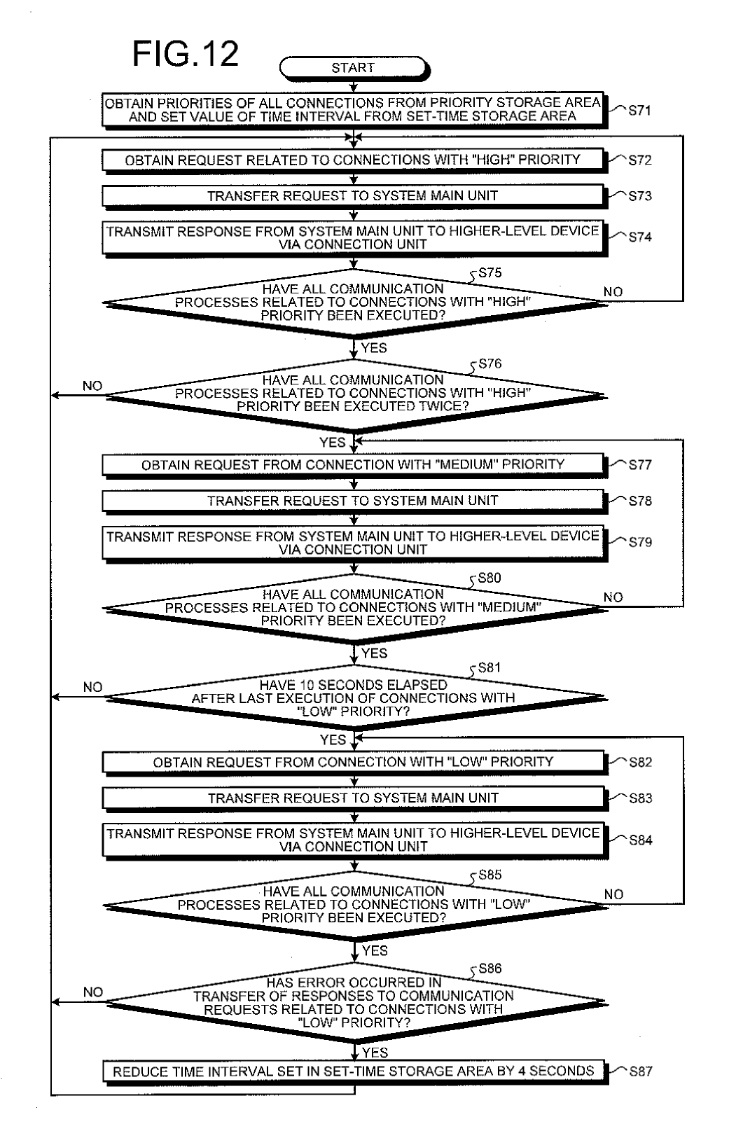

FIG. 12 is a flowchart for explaining an operation of the PLC 5 according to the third embodiment. In this case, priority information stored in the priority storage area 26 and a set value of the time interval stored in the set-time storage area 27 are same as those of the first embodiment. That is, the communication processes related to “high” priority are executed in the service process in two scans among three, and the communication processes related to connections with “medium” priority are executed in the service process in one scan among the three. The communication processes related to connections with “low” priority are executed every 10 seconds. The communication scheduling unit 51 updates the set value of the time interval with a value reduced by 4 seconds when an error occurs due to time-out, as an example.

As shown in FIG. 12, the same processes at Steps S21 to S34 in the first embodiment are executed at Step S71 to S84, respectively.

After the process at Step S84, the communication scheduling unit 51 determines whether all communication processes related to connections with “low” priority have been executed (Step S85) and, when execution thereof is not completed (NO at Step S85), the operation returns to Step S82. When all of the communications processes related to the connections with “low” priority have been executed (YES at Step S85), the communication scheduling unit 51 inquires of the connection unit 21 whether transfer of any of responses to the communication processes related to the connections with “low” priority has become an error (Step S86). When no transfer of the responses to the communication requests related to the connections with the “low” priority has become an error (NO at Step S86), the operation returns to Step S72. When transfer of any of the responses to the communication processes related to the connections with “low” priority has become an error (YES at Step S86), the communication scheduling unit 51 reduces the value of the time interval stored in the set-time storage area 27 by 4 seconds (Step S87) and then the operation returns to Step S71.

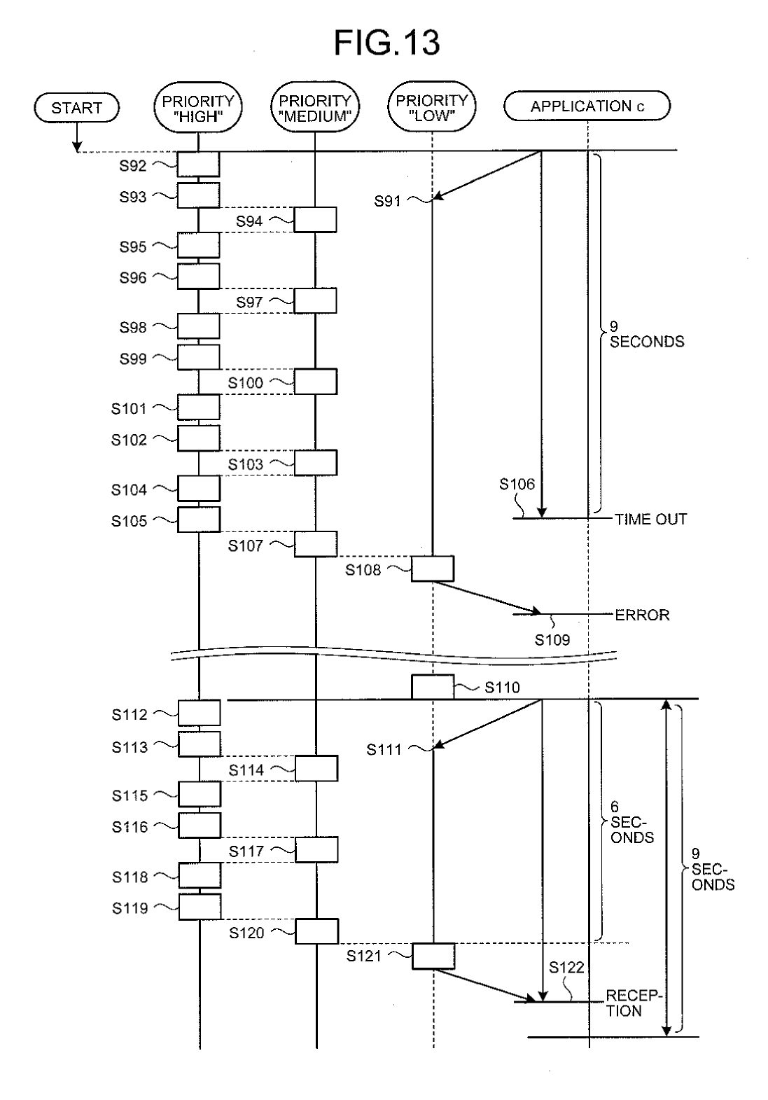

FIG. 13 is an explanatory diagram of a timeline of communication processes according to the third embodiment. FIG. 13 depicts how a request from the application “c” for which “low” priority is set is processed. The vertical axis represents time and the horizontal axis represents communication process statuses related to connections with respective priorities. Each white rectangle shows that processes related to connections with the corresponding priority have been all executed.

A request from the application “c” is stored in the communication buffer 25 (Step S91). During that time, all communication processes related to connections with “high” priority are executed twice (Steps S92 and S93). All communication processes related to connections with “medium” priority are then executed (Step S94). Processes related to connections with “high” and “medium” priorities are executed until 10 seconds have elapsed after last execution of communication processes related to connections with “low” priority (Steps S95 to S107).

During that time, 9 seconds have elapsed after transmission of the request from the application “c” and the application “c” has timed out (Step S106).

When it is detected that 10 seconds have elapsed from last execution of communication processes related to connections with “low” priority after all of the communication processes related to connections with “medium” priority have been executed, communication processes related to connections with “low” priority are executed (Step S108). A response to the request is then transferred to the application “c”. However, because the application “c” has already timed out, the response is ignored to become an error (Step S109).

When detecting that transfer of the response to the communication request related to a connection of the application “c” has become an error, the communication scheduling unit 51 reduces the time interval stored in the set-time storage area 27, at which communication request processes related to connections with “low” priority are executed, by 4 seconds.

In the processes after this operation, the time interval at which communication request processes related to connections with “low” priority are executed is 6 seconds. Specifically, immediately after the completion of communication processes related to connections with “low” priority (Step S110), a request is transmitted again from the application “c” (Step S111). At the same time, communication processes related to connections with “high” priority are started and, until the time interval (6 seconds) stored in the set-time storage area 27 has elapsed after the previous communication process related to the connections with “low” priority (processes at Step S110 in this case), communication processes related to connections with “high” priority and communication processes related to connections with “medium” priority are executed (Steps S112 to S120).

When an elapse of 6 seconds from the processes at Step S110 is detected after communication processes related to the connections with “medium” priority have been all executed, communication processes related to connections with “low” priority are executed (Step S121). The application “c” receives a response to the request (Step S122) before the time out occurs, that is, before 9 seconds have elapsed from transmission of the request in the process at Step S111.

As described above, when transfer of a response to a communication request related to a connection with the “low” priority becomes an error, the communication scheduling unit 51 reduces the time interval of communication processes related to connections with the “low” priority, thereby avoiding a communication failure due to time-out.

Because the value of the time interval is changed in the third embodiment, the frequency of communication processes is changed, which may prevent communication processes based on priorities. In order to avoid this situation, the third embodiment can be adapted to enable a user to set whether to perform the process of reducing the value of the time interval.

While 4 seconds are reduced from the time interval when transfer of any response to communication requests related to connections with “low” priority becomes an error in the above explanations, the reduction width is not limited to 4 seconds. The third embodiment can be adapted to enable the user to arbitrarily set the reduction width of the time interval.

As described above, according to the third embodiment, the communication scheduling unit 51 can reset the time interval at which communication processes related to connections with “low” priority are executed to a smaller value than the currently-set value when a time-out error occurs in a connection with “low” priority. Therefore, successive occurrence of time-out errors can be prevented. That is, a communication failure due to a time-out error in connections with “low” priority can be avoided.

### INDUSTRIAL APPLICABILITY

As described above, the programmable controller according to the present invention is suitable to be applied to a programmable controller that controls industrial devices.

### REFERENCE SIGNS LIST

1, 4, 5 PLC
2 network hub
3a, 3b PC
11 CPU
12 ROM
13 RAM
14 communication I/F
15 system program
16 user program
21, 41 connection unit
22, 42, 51 communication scheduling unit
23 system main unit
24 timer unit
25 communication buffer
26 priority storage area
27 set-time storage area
28 priority information
43 input/output memory area
44 number-of-response device
45 number-of-response storage area

1. A programmable controller provided with an input/output memory area having a device value stored therein responds, when receiving a request for a device value from an upper-level device connected to the programmable controller, the requested device value, the programmable controller comprising:
a connection unit that establishes a connection for each of applications running on the upper-level device and performs reception of a request from the upper-level device and transmission of a response to the upper-level device via the established connection for each of the applications;
a communication buffer that temporarily stores therein requests received by the connection unit for each connection;
a system main unit (a request processing unit) that reads a device value requested by the upper-level device from the input/output memory area;
a priority storage area that stores setting of a priority level for each connection; and
a communication scheduling unit that successively obtains requests from the communication buffer, transfers the obtained requests to the request processing unit, and transfers the device value, which is read by the request processing unit and corresponds to the transferred request, to the connection unit as a response, wherein
the communication scheduling unit obtains requests from the communication buffer with a higher frequency for a connection for which a higher priority is set in the priority storage area.

2. The programmable controller according to claim 1, further comprising:
a timer unit that counts elapsed time; and
a set-time storage area that stores setting of a time interval, wherein
the communication scheduling unit refers to a count value of the timer unit to determine whether the time interval set in the set-time storage area has elapsed and, when the time interval has elapsed, obtains a request related to a connection for which a specific priority level is set in the priority storage area, from the communication buffer.

3. The programmable controller according to claim 1, wherein the connection unit establishes a connection for each of the applications between a port specified by a user of an upper-level device as a connection partner and a port of its own programmable controller specified by the user.

4. The programmable controller according to claim 1, wherein
the input/output memory area includes a number-of-response device in which state information of at least for each priority related to the number of responses to the upper-level device is stored, and
the programmable controller further comprises:
a number-of-response storage area that stores the number of responses to the upper-level device for at least each priority; and
a state-information calculation unit that calculates state information based on the number of responses stored in the number-of-response storage area, and stores the calculated state information in the number-of-response device.

5. The programmable controller according to claim 4, wherein the state information is the number of responses per unit time.

6. The programmable controller according to claim 4, wherein
the number-of-response storage area stores the number of responses to the upper-level device for each connection, and state information for each connection is stored in the number-of-response device.

7. The programmable controller according to claim 2, further comprising a set-time reset unit that resets a set value of the time interval stored in the set-time storage area to a smaller value when a time-out error occurs in the connection for which the specific priority is set.
